(19) United States
(12) Patent Application Publication
(10) Pub. No.: US 2013/0340315 A1
(43) Pub. Date: Dec. 26, 2013

(54) DEER RUBBING POST

(71) Applicant: Jake D. Gustafson, Ennis, MT (US)

(72) Inventor: Jake D. Gustafson, Ennis, MT (US)

(21) Appl. No.: 13/531,830

(22) Filed: Jun. 25, 2012

(51) Int. Cl. A01M 31/06

(52) U.S. Cl. CPC A01M 31/06
USPC 43/2

(57) ABSTRACT

A rubbing post attracts deer, which like to rub on the rubbing post. The rubbing post includes a support portion and an upper portion. The upper portion includes an unrubbed portion and a rubbing portion. At least a portion of the rubbing post includes an attractive substance that emits a scent that attracts deer to the rubbing post. The post may be colored and weathered to further improve the attractiveness.

### BACKGROUND

Deer are one of the most popular game animals for hunting. Their acute sense of smell and often timid nature make deer hunting challenging.

Various techniques have been used to attract deer to hunting locations. These techniques often involve the use of food or scents to attract deer. Where legal, a bait pile such as a pile of corn can be used to lure deer to a hunting location. A food plot, such as corn, soybeans, clovers, and other types of forage plants can be grown in a field to attract deer to that location. Scents, such as doe urine, are commonly used during the mating season to attract bucks.

Deer can be very territorial, particularly during the mating season, and will often frequent the same locations. As a result, hunters often look for signs of deer activity, which can include deer beds, trails, scrapes, and rubs. A deer bed is formed when a deer lies on the ground, resulting in a region of compressed grass or other vegetation. A deer trail is a path worn on the ground where one or more deer frequently travel. A scrape is made by deer digging with their front hooves and urinating on the ground to mark their territory and as a form of communication with other deer in the area. A rub is made on small trees or brush when a buck rubs his antlers and forehead against it, often wearing off exterior portions of the plant.

### SUMMARY

In general terms, this disclosure is directed to a deer rubbing post. In one possible configuration and by non-limiting example, the deer rubbing post is a wooden post including a deer-attractive substance. Methods of making and using the deer rubbing post are also disclosed, as well as examples of deer-attractive substances.

One aspect is a rubbing post for attracting deer. The rubbing post includes a support portion and an upper portion. The upper portion is coupled to and extends from the support portion, wherein the upper portion includes an unrubbed portion and a rubbing portion. The rubbing portion and the unrubbed portion have different colors. The rubbing portion includes a deer-attractive substance, wherein the application of the deer-attractive substance occurs at a first location. The rubbing post is made available for distribution, to use the rubbing post at a second location different than the first location.

Another aspect is a method of manufacturing a rubbing post for attracting deer, the method comprising: coloring at least a portion of a post with a coloring substance; weathering the colored post to soften an exterior surface of the post, wherein the exterior surface is softer than an interior of the post; and applying a deer-attractive substance to at least a portion of the weathered post.

A further aspect is a deer-attractive substance comprising at least one deer testicle, at least one stained deer tarsal gland, at least one deer forehead gland, alcohol, glycerin, and tonquin musk.

### BRIEF DESCRIPTION OF THE DRAWINGS

FIG. 1 is a schematic diagram of an exemplary embodiment of a system for manufacturing, distributing, and installing rubbing posts for attracting deer in accordance with the aspects of the present disclosure.

FIG. 2 is a perspective view of an exemplary rubbing post installed in a field, and illustrating a deer rubbing its forehead and antlers on the post.

FIG. 3 is a schematic side view of the rubbing post shown in FIG. 2.

FIG. 4 is a flowchart of an exemplary method of manufacturing, distributing, and installing a rubbing post.

FIG. 5 is a flowchart illustrating an exemplary manufacturing operation for making the rubbing post.

FIG. 6 is a flowchart illustrating an exemplary method of coloring bare wooden posts.

FIG. 7 is a flowchart illustrating an exemplary method of weathering wooden posts.

FIG. 8 is a flowchart illustrating an exemplary method of applying an attractive substance to a post.

FIG. 9 is a flowchart illustrating another exemplary method of applying an attractive substance to a post.

FIG. 10 is a flowchart illustrating another exemplary method of applying an attractive substance to a post.

FIG. 11 is a flowchart illustrating an exemplary packaging operation, for packaging the rubbing post.

FIG. 12 is a flowchart illustrating an exemplary method of installing and using the rubbing post.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

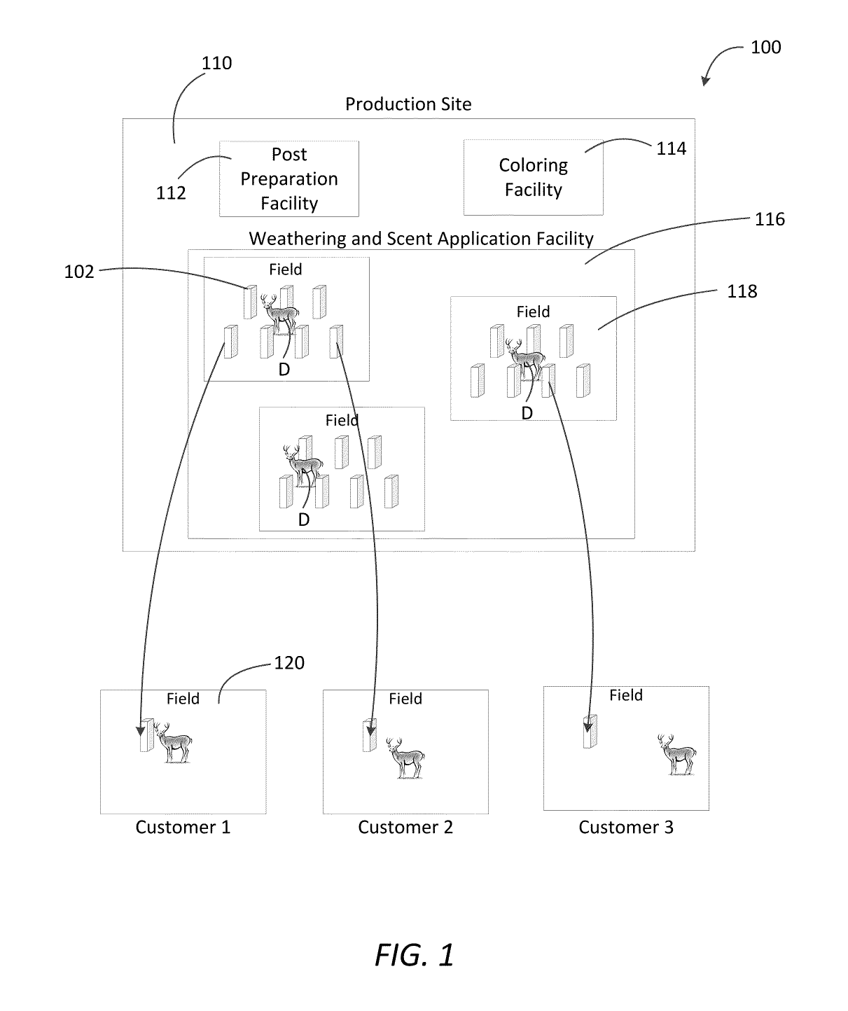

FIG. 1 is a schematic diagram of an exemplary embodiment of a system 100 for manufacturing, distributing, and installing rubbing posts 102 for attracting deer in accordance with the aspects of the present disclosure. In some embodiments, the system 100 includes a production site 110, and at least one customer's field 120 where the rubbing post 102, that is delivered from the production site 110, is used by a customer for attracting deer.

Rubbing posts 102, which are manufactured in the production site 110 and used by customers in their fields 120, are used to attract deer as described below. One common type of deer that may be attracted to the rubbing post 102 is a whitetail deer. Another type of deer is a mule deer. The rubbing posts 102 may also be useful in attracting other antlered mammals, and may even be useful in attracting predatory animals, such as wolves or coyotes that prey on antlered mammals. The term “deer” is generally used herein to refer to any antlered mammal that may be attracted to the rubbing post 102.

In some embodiments, the production site 110 includes a post preparation facility 112, a coloring facility 114, and a weathering and scent application facility 116. The post preparation facility 112 is established to prepare the posts and preprocess them before proceeding with coloring, weathering, and scent-applying operations. The coloring facility 114 is set up for coloring the surface of the posts 102. The weathering and scent application facility 116 can include one or more fields 118, on which rubbing posts 102 are arranged for weathering and scent-applying operations as described below. The weathering and scent application facility 116 can include multiple fields 118 in some embodiments. The production site 110 can be a single site or can include multiple different sites, each performing one or more of the operations of the production site 110.

In some embodiments, deer D have a territory that includes one or more of the fields 118, such that the deer D move around within one or more of the fields 118, and interact with the rubbing posts 102. In some embodiments, the production site spans multiple fields, where one field is outside of the territory of deer that live within the other field, and vice versa. In this way, separate populations of deer are utilized in the separate fields. Benefits of such an arrangement are discussed in more detail herein.

In other embodiments, the fields 118 do not have deer, and deer do not interact with the posts 102 at the production site 110. In some embodiments, the fields 118 may be any outside space in which exposure to the elements may occur. In yet other embodiments, the production site 110 does not include or involve the use of fields.

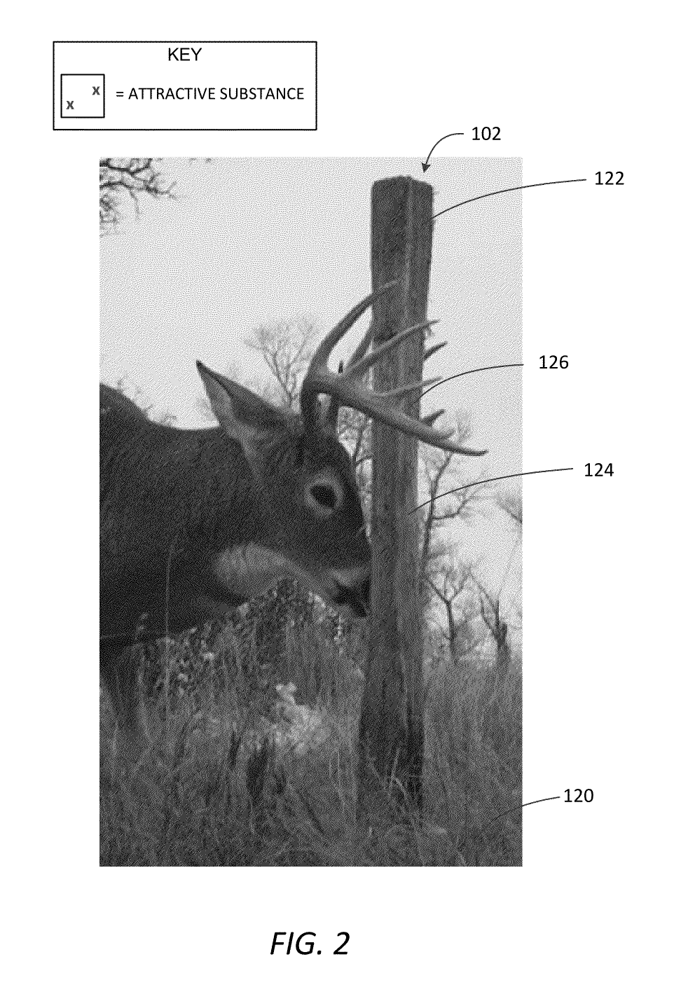

FIG. 2 is a perspective view of an exemplary rubbing post 102 in accordance with the aspects of the present disclosure. In FIG. 2, the post 102 is installed in a customer's field 120 to attract deer, and a deer has been attracted to the post 102 and is rubbing its forehead and antlers on the post 102. In some embodiments, deer are attracted to the post 102 by one or more attractive substances 126 embedded in a rubbing portion 124 of the post that emits an attractive scent. In some embodiments, deer are attracted to the post 102 by a color contrast formed between an unrubbed portion 122 and the rubbing portion 124 of the post 102, which increases the visibility of the rub, even from a distance.

In some embodiments, the post 102 is made of wood. In some embodiments, the post 102 is made of cedar wood, and some embodiments are made specifically of western red cedar. Cedar wood has its natural scent, which itself can be an attractant to deer. Thus, cedar wood can be preferable to use as rubbing posts 102 because it can contribute to the attractiveness of the rubbing posts 102. Other embodiments can be made of or include other materials, such as materials manufactured from wood (e.g., plywood, particle board, etc.), composite materials, foam, fiberglass, metal, yet other materials, or combinations of these or other materials. For example, a post 102 could be made with a metal core and wooden exterior for additional strength and durability.

The post can be installed in a customer's field 120 where it acts to attract deer to that area. The field 120 is, for example, a property or other portion of land where increased deer presence is desired, and may include a grassy prairie land, an agricultural field, a wooded area, a swamp, a suburban property, or any other location that deer inhabit.

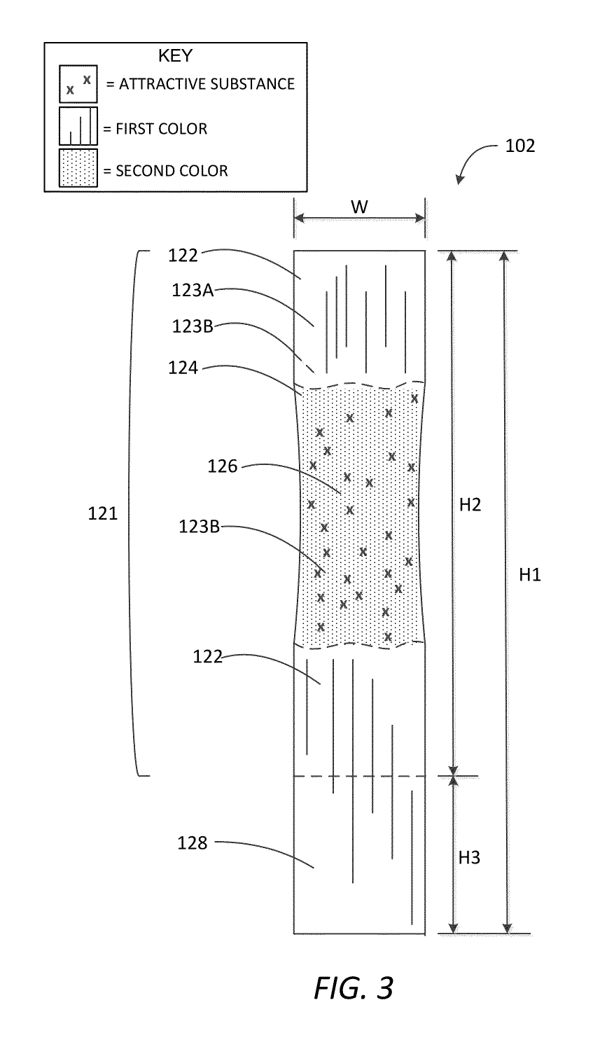

FIG. 3 is a schematic side view of the exemplary rubbing post 102 of FIG. 2. In some embodiments, the rubbing post 102 includes an upper portion 121 and a support portion 128. The upper portion includes an unrubbed portion 122 and a rubbing portion 124. The post 102 includes a weathered exterior surface 123A and an unweathered interior 123B.

The support portion 128 is a portion that can be installed into the ground of a field 120, or attached to another object, such as a concrete footing, to support the post 102 in an upright, substantially vertical, orientation. The support portion 128 and the upper portion 121 can be made of a single piece of material, or can be separate pieces that are coupled or otherwise joined together.

The upper portion 121 is a portion which is exposed above the ground when the post 102 is installed in the field 120. The upper portion 121 includes the unrubbed portion 122 and the rubbing portion 124. The rubbing portion 124 is a portion of the post where rubbing activity occurs. The rubbing portion 124 is typically spaced from the ground, since most deer to not like to rub their head and antlers at or very near to the ground. If the post 102 is sufficiently tall, the upper end of the rubbing portion 124 may be spaced from the top end of the post 102, as well.

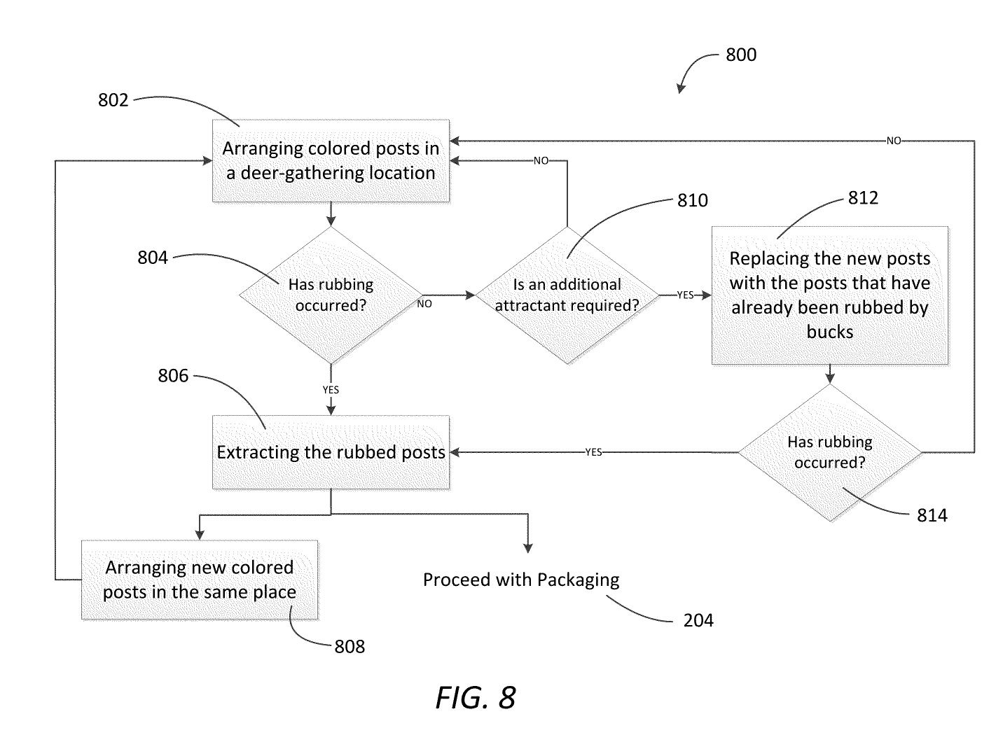

In some embodiments, the upper portion 121 of the post can include a deer attractive substance 126, which emits a scent that is attractive to deer. In some embodiments, the attractive substance 126 is arranged at least on the rubbing portion 124 of the post 102. Additional details regarding exemplary attractive substances and methods of applying the attractive substances are provided with reference to FIGS. 8-10 herein.

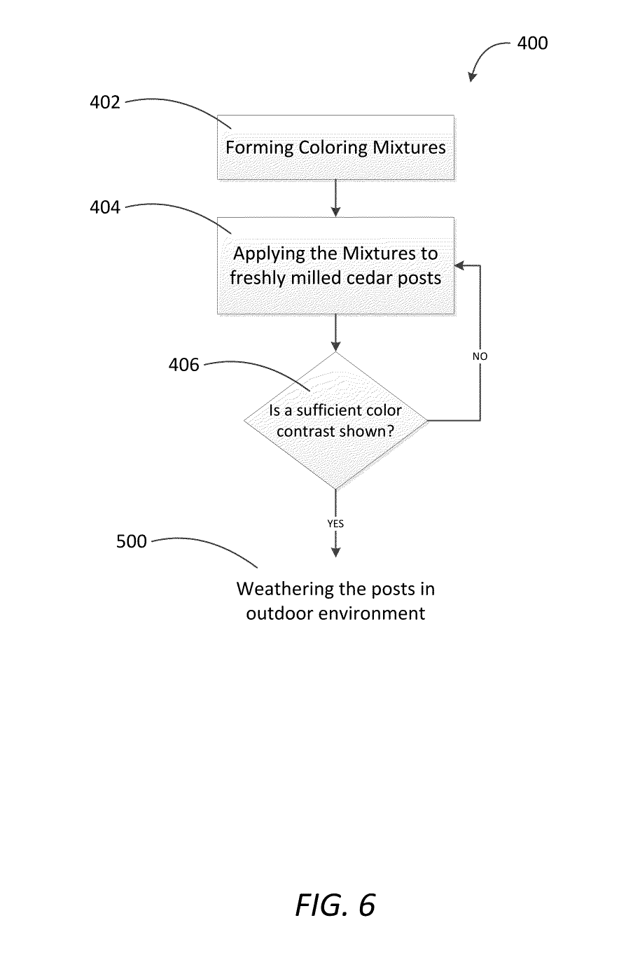

In some embodiments, the unrubbed portion 122 includes an exterior surface 123A that has been treated by such a coloring operation 400 and that is not typically involved in the deer rubbing activity. As described in detail below with reference to FIG. 6, the coloring operation changes a color of the exterior surface 123A of the post 102 so that the post 102 looks as if it has been weathered for a long time. The color of the unrubbed portion 122 is different from that of the rubbing portion 124 because the rubbing activity exposes the interior 123 of the post 102. Such color contrast between the unrubbed and rubbing portions 122 and 124 can contribute to the attractiveness of the post 102, by increasing the visibility of the rub on the post 102. For example, when deer are located far from a field on which rubbing posts 102 are installed, they may be first attracted by scents emanating from rubbing posts 102. Once deer come near to the field having the posts 102, the color contrast shown on the posts 102 can help them recognize the exact location of the posts 102 that they are pursuing. Or, in some cases, the deer may first notice the color contrast, and then come near and sense the scent on the post 102 as well.

The post 102 can have a variety of shapes and sizes. Typically the post 102 is arranged in an elongate configuration, having a width much less than its length, but other embodiments can have other shapes. For example, the post 102 could be shaped to resemble a tree, bush, or other plant. In some embodiments, the post 102 includes one or more arms that extend out from the post 102.

In some embodiments, the post has a three or four-sided cross-sectional shape, such as having a circular, squared, or triangular shape. Corners of the post 102 are rounded in some embodiments to reduce or eliminate sharp edges. Other embodiments have other shapes.

The rubbing post 102 can have a variety of thicknesses. In some embodiments, the post 102 has a diameter or a width W in a range from about 3 to about 12 inches. In another possible embodiment, the width W is in a range from about 3 to about 10 inches. In yet another possible embodiment, the width W is in a range from about 6 to about 10 inches.

The post 102 can also have a variety of lengths. In some embodiments, the post 102 has an overall height H1 in a range from about four feet to about seven feet. Although a post of any height could be made, a height that results in a post that extends significantly above the rubbing portion 124 of the post may be unnecessarily tall, resulting in excess material and shipping costs, for example, and can make handling of the post 102 during manufacturing and installation more difficult.

The height H2 is the height of the upper portion 121 of the post 102. In some embodiments, the height H2 is in a range from about three feet to about six feet.

The height H3 is the height of the support portion 128 of the post 102. In some embodiments, the height H3 is in a range from about six inches to about two feet. In some embodiments the height H3 is about one foot. However, the height (H3) of the support portion 128, and accordingly the height (H1) of the post 102, can vary depending on the condition of the ground in which the post 102 is buried. The support portion 128 of the post 102 can also or alternatively be installed into a footing or other object (such as a pot or concrete block), in other possible embodiments, and lengths of the support portion can be sized accordingly. Deer can apply a relatively large amount of force to the post 102, and therefore the support portion 128 should be adequately long to support the post 102 in the ground even with repeated deer rubbing activity.

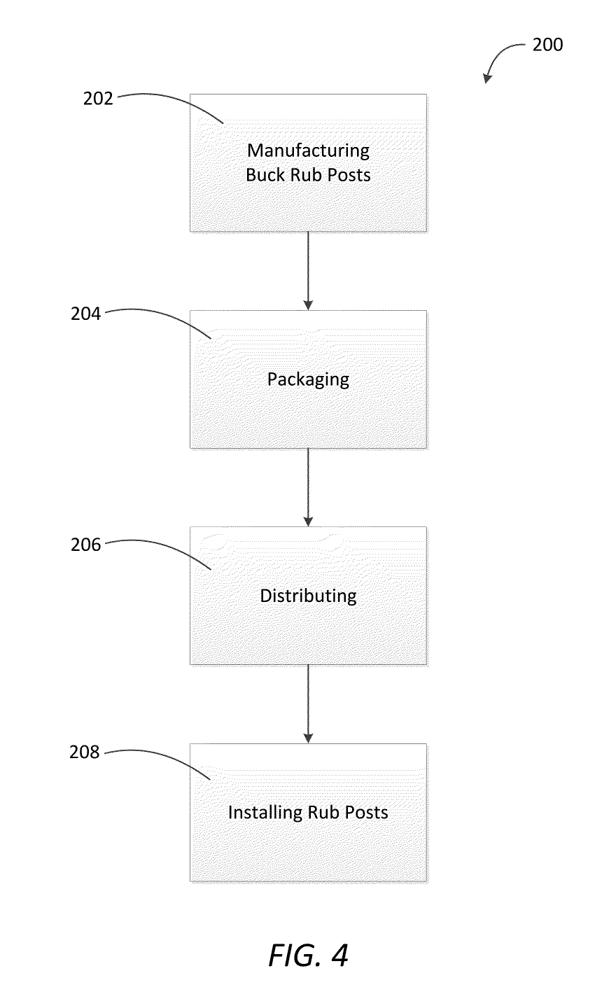

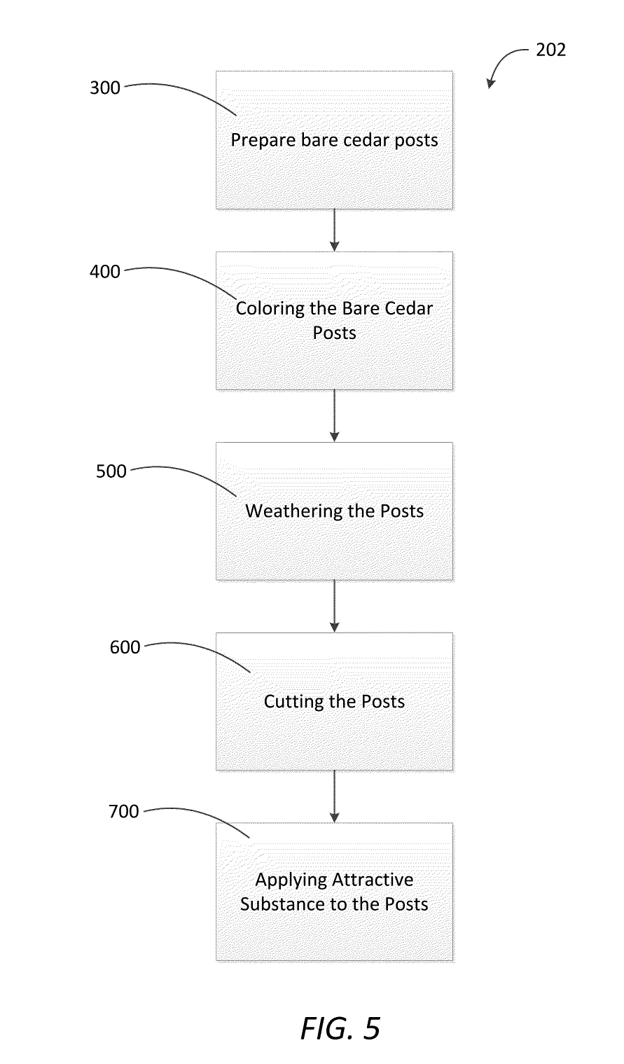

FIG. 4 is a flowchart of an exemplary method 200 of manufacturing, distributing, and installing rubbing posts 102 for attracting deer in accordance with the aspects of the present disclosure. In this example, method 200 includes a manufacturing operation 202, a packaging operation 204, a distributing operation 206, and an installing operation 208. Examples of these operations are illustrated and described in more detail below with reference to FIGS. 5-12.

The manufacturing operation 202 involves the processing of the raw materials to generate the posts 102. Manufacturing can include, for example, cutting the raw materials to appropriate sizes, coloring the materials, weathering the materials, and processes for applying scents to the materials.

After the posts 102 have been manufactured, operation 204 is performed to package the post 102 for distribution to another location. The packaging operation 204 can include wrapping the post 102 in a scent blocking material, such a plastic wrap, or vacuum sealing the post 102 within a vacuum sealing bag. The packaging can be important to seal in the scent of the attractive substances, and also to prevent the post 102 from obtaining other scents (such as human odors) during distribution.

The post 102 is then distributed from the production site to a customer's field 120 (shown in FIG. 1) in operation 206. The distributing operation 206 can also include delivery of the post 102 to a warehouse or a retail store before final delivery to the customer's field 120.

Operation 208 is then performed to install the post 102 into the customer's field, such as by digging a hole in the field 120 and inserting the support portion 128 of the post into the hole to support the post 102 in a substantially vertical and upright orientation.

FIG. 5 is a flowchart illustrating an exemplary operation 202 of manufacturing posts 102 for attracting deer. In this example, the manufacturing operation 202 includes a post preparation operation 300, a coloring operation 400, a weathering operation 500, a cutting operation 600, and a scent-applying operation 700. Examples of operations 400, 500, 600, and 700 are illustrated and described in more detail with reference to FIGS. 6-12.

In some embodiments, the post preparation operation 300 is performed in the preparation facility 112 (shown in FIG. 1) to prepare the posts 102. The preparation operation 300 can include receiving a stock of purchased milled wood material, and cutting the wood material to the appropriate size. Freshly milled wooden posts can be purchased from a mill or lumber yard, for example, and transported to the post preparation facility. It is also possible, however, that the milled wood can be purchased and obtained in the shape and size desired, such that the production site does not require further preparation operations, other than those performed at a mill or other wood processing facility.

In some embodiments, the bare materials are colored in a coloring operation 400. In the coloring operation 400, a substance is applied to the post material to give the exterior of the post a different color than the interior of the post. In some embodiments, the exterior obtains an older and more weathered looking appearance.

Operation 500 is performed in some embodiments to weather the posts. Weathering typically involves exposing the posts 102 to the elements for a period of time. The exposure to sun, wind, rain, and even ice or snow, changes the composition of at least the exterior of the post, and acts to soften and further change the color of the exterior of the post 102. Rotation of the post can be helpful to more evenly weather the exterior of the post 102.

Operation 600 is performed in some embodiments to cut the posts to an appropriate length, to create posts 102 having a desired height when installed, such as discussed herein with reference to FIG. 3.

In some embodiments, an attractive substance is applied to the post 102 in operation 700. Examples of attractive substances include natural scents applied by live deer, and scent mixtures that are applied to the post 102 by a person or machine. The attractive substance can also involve a combination of these or other substances.

FIG. 6 is a flowchart illustrating an exemplary method of coloring bare wooden posts 102. FIG. 6 is also an example of operation 400, shown in FIG. 5. Operation 400 can be performed in the coloring facility 114 as illustrated in FIG. 1. Operation 400 is performed to give the posts 102 an exterior color that is different from the interior color, resulting in a color contrast between the exterior and the interior of the post 102, as shown in FIG. 3. In some embodiments, the coloring operation 400 makes the posts 102 look as if they have been naturally weathered for a long period of time, and thus to provide a sufficient color contrast as explained above with reference to FIG. 3.

Although the weathering operation 500 can be performed without the separate coloring operation 400, the coloring operation can accelerate the weathering operation. For example, it may take as long as three years to obtain a desired weathering of a post 102 without the coloring operation. The coloring operation 400 can accelerate the process. For example, it may be possible to obtain adequate weathering in one year by including the coloring operation 400. Thus, the coloring operation 400 is performed in some embodiments to shorten a period of time for changing the color of the post surface, and to allow the post to form a sufficient color contrast when a portion of the surface of the post is rubbed off as illustrated in FIG. 3.

In some embodiments, operation 400 includes operation 402 of forming a coloring substance and operation 404 of applying the coloring substance to a freshly milled post 102 until the surface of the post 102 shows a sufficient color contrast between the interior 123B of the rubbing post 102 and the exterior surface 123A of the rubbing post 102, as shown in FIG. 3. When the coloring operation 400 is complete, the weathering operation 500 is then performed.

In some embodiments, the coloring substance is made from a mixture of steel wool, vinegar, and rusted metal pieces. For example, steel wool and rusted metal pieces can be immersed in a container containing about one gallon of vinegar. When the rust has been removed from the metal pieces soaked in vinegar, the metal pieces can be removed from the mixture. The mixture can be left to sit for about 30 to 60 days until the rust and steel wood have completely dissolved in the vinegar. The rusted metal pieces can be obtained from a variety of sources such as rusted nails, rusted staples, and rusted barbed wire. Rust can be quickly formed on many untreated metals by exposing them to the elements.

When the coloring substance is ready, operation 404 can be performed to apply the substance to the surface of wooden posts. The coloring substance made at operation 402 can be sprayed to the full length of freshly milled wooden posts. The application of the substance changes the color of the posts from fresh wood to rustic wood as if the posts had been weathered in outdoor environment for years. The spraying operation 404 can be repeated until the coloring substance is sufficiently applied on the surface of posts to provide an enough color contrast between the interior and exterior of the posts (operation 406). The spraying operation 404 can be performed with any suitable type of equipment to apply the coloring substance to wooden posts. A handheld sprayer can be used to perform the spraying operation 404, for example.

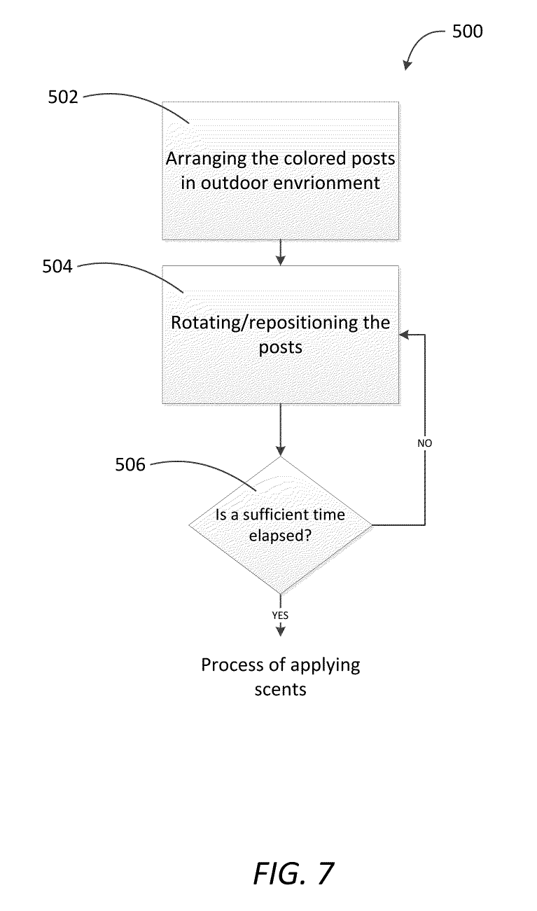

FIG. 7 is a flowchart illustrating an exemplary method of weathering wooden posts. FIG. 7 is also an example of operation 500. Operation 500 can be performed in the weathering and scent application facility 116 as depicted in FIG. 1. In this example, the weathering operation 500 includes operations 502, 504, and 506. The weathering operation 500 is performed to soften the surface of the rubbing posts 102 processed with the coloring operation 400. It has been found that deer are more likely to approach and rub on wooden posts with a softer surface. Freshly milled wooden posts having a relatively hard surface are therefore not as effective in attracting deer for rubbing as wooden posts that have undergone the weathering operation 500. It has also been found that, without the coloring operation 400 and the weathering operation 500, it usually takes more than three years to adequately weather a wooden post to a point where it has a sufficient color contrast between its interior 123B and the exterior surface 123A, and to adequately soften the surface of the post 102. Therefore, together with the coloring operation 400, the weathering operation 500 can shorten the overall time for manufacturing wooden posts for attracting deer. For example, the coloring and weathering operations 400 and 500 may be able to be completed in approximately one year.

At the operation 502, posts 102 processed with the coloring operation 400 are be arranged in an outdoor environment, such as the fields 118 as illustrated in FIG. 1, or another location. In some embodiments, rubbing posts 102 can be arranged to rest against a fence line built on the fields 118, for example. Alternatively, posts 102 can be laid on the ground. The posts 102 are then exposed to the natural environment including sun, wind, and rain. Additionally, microorganisms may also interact with the posts 102. Under these environments, the exterior 123A of the posts 102 can be steadily softened to have a suitable texture and hardness.

Operation 504 is performed to periodically rotate or reposition the rubbing posts 102 so that all surfaces of the post 102 are uniformly exposed to the weathering process. In some embodiments, the operation 504 can be conducted on a weekly, bi-weekly, or monthly basis, for example.

The weathering operation 500 can continue to be performed until rubbing posts 102 have a surface texture that is sufficiently soft to attract deer to rub on them (operation 506). In general, the longer the weathering operation 500 is performed with rubbing posts 102, the softer texture the rubbing posts 102 can have on its surface. In some embodiments, the weathering operation 500 can be performed for at least about one year.

Referring back to FIG. 5, the cutting operation 600 can be performed to cut wooden posts 102 to a length (H1) suitable for deer rubbing. Such a suitable length (H1) can range from three to seven feet, as illustrated above in references to FIG. 3. Thus, when rubbing posts 102 are taller than the length (H1), they can be cut into the length (H1).

In one embodiment, the cutting operation 600 can be performed when the coloring operation 400 and the weathering operation 500 are complete. The cutting operation 600 conducted after the coloring and weathering operations 400 and 500 can reduce the number of pieces of wooden posts that are used in the coloring and weathering operations, and thus can help reducing the number of the coloring and weathering operations accordingly. In another embodiment, however, the cutting operation 600 can be performed at the post preparation operation 300 before the coloring and weathering operations 400 and 500 are performed.

Referring back to FIG. 5, the manufacturing operation 202 further includes the scent-applying operation 700 to apply an attractive substance to the post 102. The scent-applying operation 700 can be performed at the weathering and scent application facility 116 as illustrated in FIG. 1. The scent-applying operation 700 can be performed in at least three different ways: (1) passive application of scents (operation 800); (2) active application of scents (operation 900); and (3) the combination of passive and active applications (operation 1000). Examples of each of operations 800, 900, and 1000 are illustrated and described in more detail herein with reference to FIGS. 8, 9, and 10, respectively.

FIG. 8 is a flowchart illustrating an exemplary method of applying an attractive substance to a post 102. FIG. 8 is also an example of a passive scent-applying operation 800 after the coloring and weathering operations 400 and 500 are performed. In this example, the passive scent-applying operation 800 includes operations 802, 804, 806, 808, 810, 812, and 814.

The passive scent-applying operation 800 utilizes deer's rubbing activity at the production site 110 to apply an attractive substance that emits a scent. The deer's rubbing activities naturally occur in the late summer or early fall. The rubbing activity is made for several reasons. For example, deer begin to rub to remove the velvet off their antlers newly acquired over summer. Deer also rub as a way to mark their territory. By rubbing, deer can leave scents that communicate their territory to other deer, and can also attract possible mates. Attractive substances are secreted from a glands (i.e., scent glands) in the bodies of deer. Examples of such glands include the forehead gland, the preorbital gland located near the corner of the eye, the tarsal gland located on the inner side of the hind legs, the metatarsal gland located on the outer side of the hind leg, the interdigital gland located between the toes, preputial gland located in the male reproductive organ. Deer's rubbing activity causes the scents released from deer's glands to be applied to and embedded in the rubbing portion 124 of rubbing posts 102. Because deer are very sensitive to scents left by other deer, the scents embedded in the rubbing portion 124 by the passive scent-applying operation 800 can be highly attractive to other deer. During the mating season in particular, a deer that finds the scent of another deer within his territory may have a strong reaction to the presence of the scent within his territory, and may aggressively mark the post 102 with his own scents to inform the intruder of his presence.

At operation 802, the rubbing posts 102 are arranged on the fields 118 in the weathering and scent application facility 116. To expedite the scent-applying operation, the posts 102 can preferably be arranged in deer-gathering locations. The deer-gathering locations can be an area that is known to be frequently visited by deer in the fields 118. For example, the posts 102 can be placed in natural funneling locations, such as a narrow portion of a wooded area, or near the location of a bridge or culvert across a waterway that deer will use to cross the waterway. In some embodiments, the posts 102 are placed at the location of a previous post that has been habitually used by deer for rubbing. The deer may frequently return to this post to check whether other deer have visited the post, and to remark the post with fresh scent, and the new post will often continue to be used out of habit. A manmade scent mixture can also be applied to the post to increase the attractiveness of the post, to encourage deer to use the post for rubbing, as described in more detail herein. In some embodiments, posts 102 are placed near food plots or other food sources to increase the likelihood that deer will rub on the post 102.

At operation 804, a manufacturer can periodically monitor whether the posts 102 arranged on the fields 118 have been rubbed by deer. The posts can be examined by the manufacturer to see whether the surface of the posts has been scraped by deer. The fact that a post has been rubbed by deer may also be seen by the presence of shavings laying on the ground adjacent to or surrounding the post.

When the post 102 is found to have been rubbed by deer, operation 806 is performed to extract the rubbed post, which is to be packaged at operation 204. After the operation 806, operation 808 is subsequently performed to replace the extracted post with a new post. In some embodiments, the new post is made utilizing the coloring and weathering operations described herein, and can be arranged in the same spot as an extracted one, if desired, to improve the likelihood that a deer will rub on that post 102. It has been found that, once a deer begins to rub on a post 102, the deer will continue to come to the location over and over again, even if scents or other attractants that may have previously attracted the deer are no longer present in the location. Thus, even after the posts 102 on which deer rubbed have been replaced with new ones, deer come to the same location to rub against the new posts 102. With the new posts 102 arranged on the same place, the operation 804 and the subsequent operations are performed again.

In another embodiment, operations 810, 812, and 814 can be additionally performed. For example, if it is found that the posts 102 arranged on the fields 118 have not been used by deer for a while (operation 804), a manufacturer can decide to apply an additional attractant (operation 810). Then, a manufacturer can replace the posts planted on the fields with other wooden posts (operation 812). Such other wooden posts can be ones that have already been rubbed by deer in the same field, in another field, or within a different natural territory of deer. Because the other posts already have scents embedded therein, they are more likely to attract deer to come to the location. For example, when new posts are introduced into a certain natural territory of deer from a different natural territory, the scents embedded in such new posts are unfamiliar to deer in the territory, and thus encourage their territorial behavior of leaving their scents on the new posts to warn the intruder of the presence of the deer in that territory. As such, operation 812 can increase the chance of deer utilizing the post 102, thereby leaving their scent on the post 102.

At operation 814, whether deer end up coming to the location can be determined by the same operation as the operation 804. When the posts are found to have been rubbed by deer, they can be replaced by new ones, and deer are likely to come to the place to rub their body to the new posts. After that, the operations 804, 806, 808, and 204 can be performed again for the new posts.

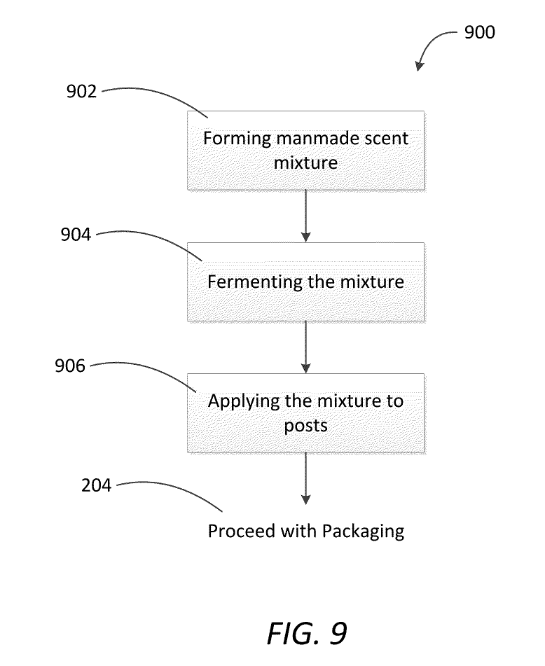

FIG. 9 is a flowchart illustrating another exemplary method of applying an attractive substance to a post. FIG. 9 is also an example of an active scent-applying operation 900 after the coloring and weathering operations 400 and 500 are performed. In this example, the active scent-applying operation 900 includes operations 902, 904, and 906. In particular, the active scent-applying operation 900 utilizes a manmade deer attractive substance, which may be made by the manufacturer. The manmade substance may include one or more natural or artificial substances that are applied by a human or machine to the post 102.

At operation 902, a deer-attractive substance is formed. In some embodiments, the deer-attractive substance is a mixture of one or more of the following: one or more deer testicles, one or more stained deer tarsal glands, one or more deer forehead glands, alcohol, glycerin, and tonquin musk.

A specific example of a recipe for a deer-attractive substance will now be described, but this recipe is provided by way of example only. Other recipes can be used in other embodiments, and other quantities and techniques may also be used. In this example, a quantity of the deer-attractive substance is formed in container, such as a one quart jar. At least one deer testicle is cut open and is placed in the container. One stained tarsal gland is added. Stained tarsal glands are tarsal glands that have a darker color (i.e., brown or black) than the typical natural white color of the inside of the a deer's hind legs. The staining is believed to occur through repeated urination on the tarsal glands area of the legs. At least one deer forehead gland is added in the container. Then, 10 oz. of alcohol and 10 oz. of glycerin are added in the container. The alcohol used herein can be at least 100-proof alcohol, or can be vodka or pure alcohol. Last, 5 drops of tonquin musk are added in the container. Then, the mixture in the container is shaken well to mixed together. The steps may be performed in different orders, and one or more of the steps or ingredients may be omitted—or one or more additional steps or ingredients may be added—to form yet other embodiments. Other embodiments include different mixtures.

Another example of a possible recipe for a deer-attractive substance is as follows. The deer-attractive substance can be formed of a mixture of at least two deer testicles, at least one stained deer tarsal gland, at least one deer forehead gland, vanilla extract, tonquin musk, and cedar shavings. Specifically, 10 oz. of alcohol, 10 oz. of glycerin, the content of two deer testicles, one stained deer tarsal gland, one deer forehead gland, five drops of vanilla extract, five drops of tonquin musk, and one table spoon of cedar shavings, are added in a container in this example. The mixture is then shaken to mix together. The cedar shaving can increase the attractiveness of the mixture because it is aromatic and attractive to deer. Preferably, the cedar shavings used in this mixture can be the ones that are formed by deer's rubbing activity on a wooden post (such that the shavings themselves contain scents from the glands of one or more deer), and can be collected from the ground near the posts 102. Alternatively, or additionally, other food sources can be used as an ingredient if they are things that deer like. For example, apples or crushed acorns can be used in the mixture, in some embodiments.

The amount of each ingredient can vary depending on the relative amount of other ingredients. The ingredients in the mixtures are not limited to the ones disclosed above, and any other deer scents or attractants can be added to the mixtures explained above to enhance the attractiveness of the deer-attractive substance. Furthermore, deer testicles, deer tarsal glands, and deer forehead glands, all of which are used in the mixtures above, can be the ones obtained from whitetail deer, mule deer, or other antlered mammals.

At operation 904, in some embodiments the mixtures formed above are fermented to make scents more attractive to deer. The fermentation can be performed at a room temperature for at least about a year. It is preferable to keep the temperature for fermentation above the freezing point in order to prevent the fermenting process from stopping or slowing down, or additional time for fermentation may be desired. The temperature and the period of fermentation can vary depending on a variety of conditions.

At operation 906, the fermented mixture is applied to posts 102 which have been colored and weathered according to the operations 400 and 500, described herein. The posts 102 now having the mixture applied are ready for the packaging operation 204.

In some embodiments, prior to applying the deer-attractive substance to the posts 102, at least a portion of the exterior surface 123A of the posts 102 is scraped off by the manufacturer to begin or increase the extent of formation of the rubbing portion 124. For example, a portion of the exterior surface 123A of the post 102 can be carved, scraped, or sanded to remove part of the exterior surface 123A and expose the interior 123B of the post 102, as illustrated in FIGS. 2 and 3. This creates or improves the appearance of prior rubbing on the post 102, and may can increase the color contrast between the rubbing portion 124 and the unrubbed portion 122.

In other embodiments, the mixtures manually formed as the deer-attractive substance, as described above in reference to FIG. 9, can be manufactured as separate products that are distributed for application by customers. For example, customers can apply them to the posts 102 of the present disclosure once they are delivered to the customer's field 120, or to posts 102 that are already installed and in use in the customer's field 120.

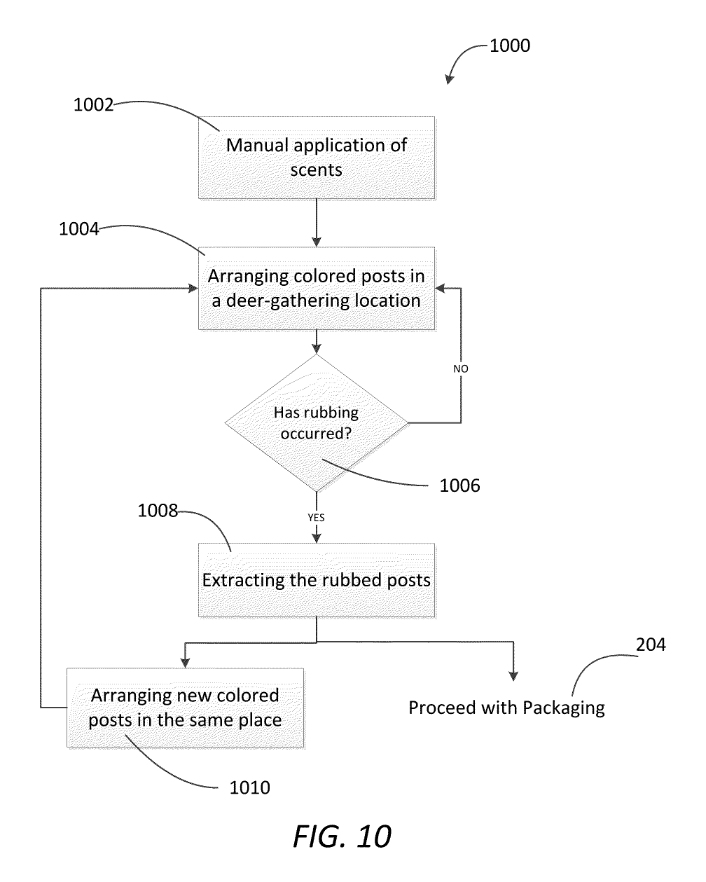

FIG. 10 is a flowchart illustrating an exemplary method of applying an attractive substance to a post. FIG. 10 is also an example of an operation 1000 involving a combination of the passive and active scent-applying operations 800 and 900. The operation 1000 can further increase the attractiveness of posts 102. In this example, the operation 1000 includes operations 1002, 1004, 1006, 1008, and 1010.

In some embodiments, operation 1002 starts with the active scent-applying operation 900. As explained above, the deer-attractive substance is formed and applied to wooden posts that have already undergone the coloring and weathering operations 400 and 500. Then, the passive scent-applying operation 800 can be performed with the wooden posts. In particular, operation 1004 is performed to arrange the wooden posts in a deer-gathering location, and then the posts are monitored to find whether they have been rubbed by deer (operation 1006). When it is found that the posts have been rubbed by deer, operation 1008 is performed to extract the rubbed posts to proceed with the packaging operation 204. The extracted posts can then be replaced by new posts at the same location, to perform another round of passive scent-applying operation (operation 1010).

In another embodiment, the passive scent-applying operation 800 is first performed, being followed by the active scent-applying operation 900. For example, while the passive scent-applying operation 800 is performed as illustrated in FIG. 8, the deer-attractive substance formed by a manufacturer, as explained in reference to FIG. 9, can be applied to the posts arranged in the fields for the passive scent-applying operation. This can increase the chance that deer visit the fields to rub their body against the posts arranged thereon.

When at least one of the passive scent-applying operation 800, the active scent-applying operation 900, and the combination thereof 1000 is performed, the wooden posts can have deer attractive substances 126 embedded in their surface, as illustrated in FIG. 3. Therefore, the deer attractive substance 126, as well as the color contrast created between the unrubbed portion 122 and the rubbing portion 124 of the post 102, can both contribute to attracting deer to the post, and encourage them to rub their antlers and bodies (including their forehead and possibly other glands) against the post. Urination or other scent application may also occur in the area surrounding the post, further acting to increase the chance of deer activity in that area.

Referring back to FIG. 4, the manufacturing operation 202 is followed by the packaging operation 204.

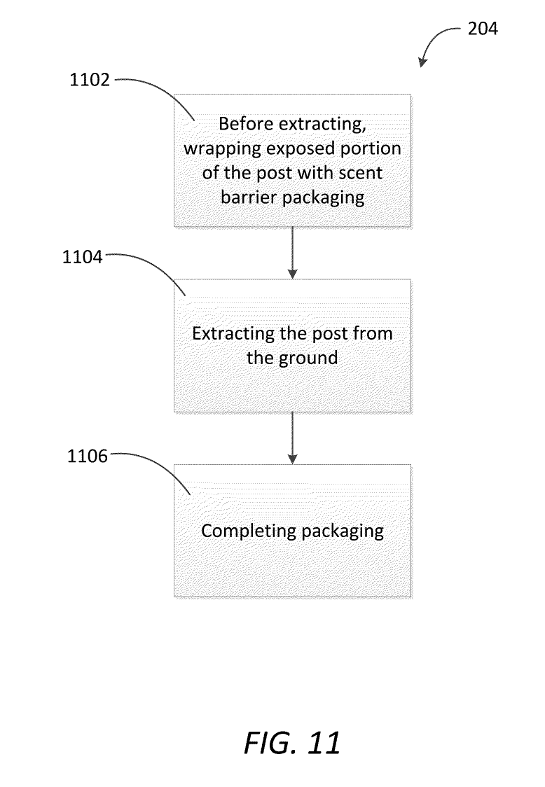

FIG. 11 is a flowchart illustrating an exemplary method of packaging a rubbing post 102. FIG. 11 is also an example of the packaging operation 204. In this example, the packaging operation 204 includes operations 1102, 1104, and 1106.

Deer are very sensitive to different kinds of scents, and can be fearful of certain scents—particularly to human scent. As a result, it is important not to contaminate the posts 102 with such scents during distribution. It is also desirable to seal in the deer-attractive scents added during the manufacturing operation 202, to avoid losing those scents during distribution.

To prevent such contamination of the post with human scents, an operation 1102 is performed before extraction of the post 102 from the ground . In operation 1102, the upper portion 121 of the post 102 is wrapped or otherwise enclosed within a scent blocking material. The upper portion 121 can then be handled without contaminating the upper portion 121 with human scents.

When the exposed portion is properly packaged, operation 1104 is then performed to extract the post from the ground. This can be performed manually by pulling, lifting, or digging the post 102 from the ground, or with a machine, such as a crane, skid loader, etc.

Operation 1106 is then performed to finish the packaging of the rest of the post 102 with a scent blocking material. Throughout the packaging operation 204, the manufacturer can use clean scent-blocking rubber gloves to perform the packaging operation 204, and further reduce the chance of human scent being applied to the post 102. Once the post 102 is wrapped or otherwise enclosed in scent blocking material, one or more additional packaging layers may be applied, such as a bubble wrap, Styrofoam, a cardboard box, or other types of packaging, in preparation for distribution to the customer.

Referring back to FIG. 4, the packaging operation 204 is followed by the distributing operation 206. Once one or more of the posts 102 have been packaged, they are then distributed to the customer for use. Distribution may involve one or more carriers, such as the United States Postal Service, United Parcel Service, FedEx, private courier, or any other distribution service. In some embodiments the post 102 is picked up directly by the customer from the production site 110.

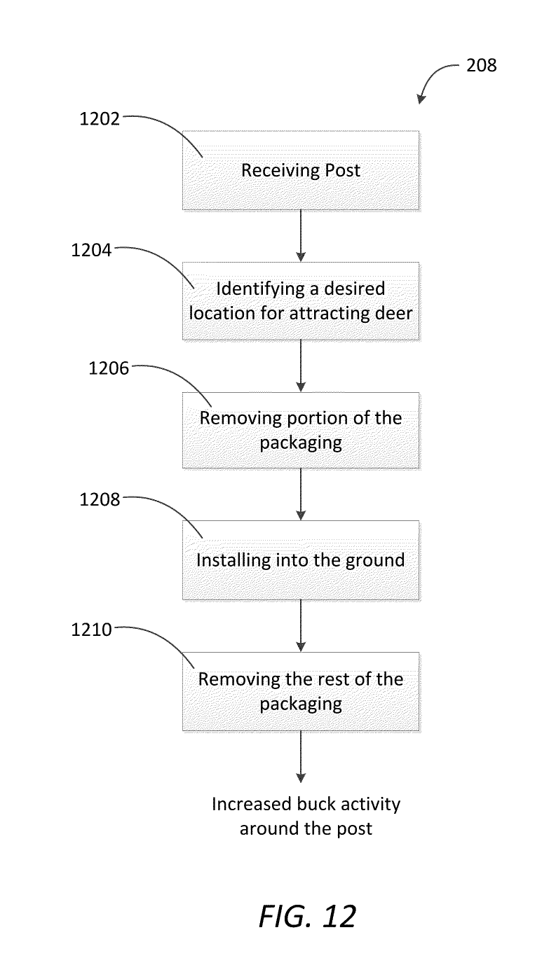

FIG. 12 is a flowchart illustrating an exemplary method of installing and using the rubbing post 102. FIG. 12 is also an example of the installing operation 208 performed by customers. In some embodiments, the installing operation 208 includes operations 1202, 1204, 1206, 1208, and 1210.

Operation 1202 is performed when a customer receives the rubbing post 102. When the customer wants to use the post 102 to attract deer for hunting, the customer identifies a desired location to install the post 102, in operation 1204. The post 102 can be installed any location within (or near to) the deer's natural territory where the customer wants to attract deer. In one example embodiment, customers can use a plurality of the posts 102 to make rub lines. The posts can be placed on the down-wind side of bedding areas, or in funneling locations. The posts can also be located near an existing hunting location (such as near a tree stand or blind) to attract deer near those locations during the hunting season. In other instances, the posts 102 may be installed near a food plot or field edge.

Operation 1206 is then performed in some embodiments to remove only a portion of the packaging to expose the support portion 128 of the post 102, while keeping the packaging on the upper portion 121.

Operation 1208 is then performed to dig a hole in the ground and insert the support portion 128 of the post 102 into the ground, or other supporting object. A post digger or shovel can be used to dig the hole in some embodiments. In some embodiments, the support portion 128 of the wooden post is buried about one foot in the ground. But the length (H3) of the support portion 128 can vary depending on the condition of ground in which the post is buried. In another embodiment, to fix the post 102 firmly in the ground, concrete can be used to form a footing. In some embodiments, the post is installed so that the upper portion 121 extends at least three feet high to allow deer to rub thereon conveniently.

When operation 1208 of installing the support portion 128 is completed, the rest of the packaging can then be removed in operation 1210.

Throughout the installing operations 208, it is beneficial to avoid handling the post 102 by handling only the packaging, and removing the portions of the packaging at the appropriate times, as discussed herein. Otherwise, the post 102 can be easily contaminated by human scents of the customer handling the post, which may reduce the attractiveness of the post to a deer. Customers can further reduce the risk of contaminating the post 102 by wearing scent-free rubber gloves while handling the post.

In addition to the use of the post 102 for hunting, the post 102 can also be used for other purposes. One example is to attract deer to a location for viewing, such as outside of a home or cabin where people can enjoy watching the deer outside. Another example is to reduce damage to property or plants caused by deer rubbing. The post 102 can be used to encourage rubbing on the post 102, and in turn discourage rubbing on the other property or plants.

The various embodiments described above are provided by way of illustration only and should not be construed to limit the claims attached hereto. Those skilled in the art will readily recognize various modifications and changes that can be made without following the example embodiments and applications illustrated and described herein, and without departing from the true spirit and scope of the following claims.

What is claimed is:

1. A rubbing post for attracting deer, the rubbing post comprising:
a support portion; and
an upper portion coupled to and extending from the support portion, wherein the upper portion includes an unrubbed portion and a rubbing portion, wherein the rubbing portion and the unrubbed portion have different colors, and the rubbing portion includes a deer-attractive substance, wherein the application of the deer-attractive substance occurs at a first location;
wherein the rubbing post is made available for distribution, to use the rubbing post at a second location different than the first location.

2. The rubbing post of claim 1, wherein the post includes an exterior surface and an interior, the exterior surface having a first color and the interior having a second color, wherein the exterior surface is present at the unrubbed portion and wherein the interior is exposed at the rubbing portion.

3. The rubbing post of claim 1, wherein the deer-attractive substance includes a natural substance secreted from a body of a deer in the course of rubbing against the rubbing portion.

4. The rubbing post of claim 3, wherein the first location and the second location are different natural deer territories.

5. The rubbing post of claim 1, wherein the deer-attractive substance includes a mixture of at least one deer testicle, at least one stained deer tarsal gland, at least one deer forehead gland, alcohol, glycerin, and tonquin musk.

6. The rubbing post of claim 5, wherein the deer-attractive substance further includes vanilla extract and cedar shavings.

7. The rubbing post of claim 6, wherein the cedar shavings are formed on the ground adjacent a cedar post, the cedar post being rubbed by deer.

8. The rubbing post of claim 5, wherein the mixture is fermented above a freezing point of the mixture.

9. The rubbing post of claim 1, wherein the rubbing post is made from western red cedar.

10. A method of manufacturing a rubbing post for attracting deer, the method comprising:
coloring at least a portion of a post with a coloring substance;
weathering the colored post to soften an exterior surface of the post, wherein the exterior surface is softer than an interior of the post; and
applying a deer-attractive substance to at least a portion of the weathered post.

11. The method of claim 10, wherein applying a deer-attractive substance occurs at a first location, and further comprising:
distributing the post to a second location, the second location being different than the first location.

12. The method of claim 10, wherein the coloring substance includes a mixture of steel wool, vinegar, and rusted metal pieces.

13. The method of claim 10, wherein applying a deer-attractive substance to at least a portion of the weathered post comprises:
arranging the weathered post in a deer-gathering location;
determining that the post has been rubbed by a deer;
removing the rubbed post from the deer-gathering location; and
arranging a second weathered post in the location from which the rubbed post has been removed.

14. The method of claim 10, wherein applying the deer-attractive substance to at least a portion of the weathered post comprises arranging the weathered post in a location of frequent deer activity to obtain the deer-attractive substance from at least one deer when the at least one deer rubs on the weathered post.

15. A deer-attractive substance comprising at least one deer testicle, at least one stained deer tarsal gland, at least one deer forehead gland, alcohol, glycerin, and tonquin musk.

16. The deer-attractive substance of claim 15, further comprising a deer-attractive food source.

17. The deer-attractive substance of claim 16, wherein the deer-attractive food extract is selected from the group consisting of vanilla extract, apple extract, and crushed acorns.

18. The deer-attractive substance of claim 15, further comprising cedar shavings.

19. The deer-attractive substance of claim 18, wherein the cedar shavings are formed by deer rubbing on a cedar post.

20. The deer-attractive substance of claim 15, wherein the mixture is fermented at a temperature above a freezing point of the mixture.
